(19) United States
(12) Patent Application Publication
(10) Pub. No.: US 2007/0155410 A1
(43) Pub. Date: Jul. 5, 2007

(54) Device and method for sending reply or forward messages in mobile communication terminal

(75) Inventors: Young-Mi Kim, Seoul (KR); Seung-Hun Yoo, Seoul (KR); Byeong-Cheol Hwang, Seoul (KR); Jin-Young Jeon, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/647,933

(22) Filed: Dec. 29, 2006

(30) Foreign Application Priority Data
Dec. 29, 2005 (KR) 2005-133737

(51) Int. Cl. H04Q 7/20

(52) U.S. Cl. 455/466; 709/206

(57) ABSTRACT

Disclosed are a device and a method for sending or receiving a reply or forward message in a mobile communication terminal. When a user selects a reply or forward menu in relation to a specific original message, the title of the original message is extracted and set as the title of a reply or forward message. The number of messages having the same title as the original message is determined to generate an indication of the number of replies or forwards. According to the user's selection of the reply menu or the forward menu, a title header including a prefix indicating a reply or a forward and the indication of the number of replies or forwards is generated and inserted into a reply or forward message input window. A recipient of the reply or forward message can easily perceive whether the received message is a reply or a forward. The recipient can also perceive the number of replies exchanged between the two mobile communication terminals or the number of times the original message has been forwarded.

### PRIORITY

This application claims priority to an application entitled “Device and Method for Sending Reply or Forward Messages in Mobile Communication terminal” filed with the Korean Intellectual Property Office on Dec. 29, 2005 and assigned Serial No. 2005-133737, the contents of which are incorporated herein by reference.

### BACKGROUND OF THE INVENTION

1. Field of the Invention

The present invention relates to a mobile communication terminal, and more particularly to a device and method for sending a reply or forward message in a mobile communication terminal.

2. Description of the Related Art

A reply message refers to a new message sent to an original message sender in response to an original message. Generally, a reply message includes “RE:” as an abbreviation of the word “reply” in a header so that the recipient, i.e. the original message sender, can perceive it as a reply to the original message.

A forward message refers to an original message forwarded by the recipient to a third party, rather than to the original message sender. Generally, a forward message includes “FW:” as an abbreviation of the word “forward” in a header to indicate that it is a forwarded message.

The indication of a reply message or a forward message is commonly used in e-mails sent on a personal computer. The prefixes, such as RE and FW, in the subject line in e-mail messages shows the history of each message. For example, if a sender A sends a reply message to an original sender B and the original sender B sends again another reply message to the sender A, the latter reply message sent to the sender A will include a prefix “RE:RE:” indicating that it is a second reply.

The message replying or forwarding method used in e-mail messages is also used in message services on mobile communication terminals, such as SMS (Short Message Service) and MMS (Multimedia Messaging Service). In other words, if a user C of a mobile communication terminal receives an SMS or MMS message, the user C can send a reply or forward message to another mobile communication terminal by selecting a reply or forward menu item. However, messages exchanged between mobile communication terminals do not include a header due to the limited storage capacity of the mobile communication terminals and the limited number of characters capable of being input in a message.

FIGS. 1A to 1D illustrate exemplary displays of messages exchanged between conventional mobile communication terminals. Particularly, FIG. 1A illustrates a display of a list of received messages. When a user selects one from the displayed list, the selected message is displayed as illustrated in FIG. 1B. FIG. 1C illustrates a display of a reply message input by the user in response to the selected original message. FIG. 1D illustrates a list of received messages which is displayed on the recipient's (i.e. the original message sender's) mobile communication terminal.

More specifically, when the user selects a received message from the displayed list of FIG. 1A, the full text of the selected message is displayed as illustrated in FIG. 1B. When the user selects a menu button during the display of FIG. 1B and then a reply item under the menu, a reply message input window as illustrated in FIG. 1C is displayed so that the user can input a reply message to the received original message. When the reply message is sent, it will then be displayed on the recipient's (i.e. the original message sender's) mobile communication terminal as illustrated in FIG. 1D.

As can be seen from FIGS. 1C and 1D, when a reply message function is selected in a conventional mobile communication terminal, only a mobile phone number included in the sender information of the original message is automatically input in the reply message input window. Although the reply message input method in a conventional mobile communication terminal eliminates the need to directly input the mobile phone number of the original message sender, it is almost identical to a new message input method. A reply message sent to the original message sender is displayed on the original message sender's mobile communication terminal as illustrated in FIG. 1D. However, the original message sender cannot confirm whether the received message is a reply to his or her original message or a completely new message until or unless the received message is opened. Even if several reply messages are exchanged between two mobile communication terminals, the users will not be able to confirm whether the currently received message is a reply to the previous message or how many reply messages have been exchanged, without opening the received message.

The same problems can be said of a forward message function in a conventional mobile communication terminal. When a user forwards a received message to a third party other than the original message sender, the forward message does not include any indication of having been forwarded. The third party who receives the forward message cannot confirm whether the received is a new message or a forward message until or unless the received message is opened.

### SUMMARY OF THE INVENTION

Accordingly, the present invention has been made to solve at least the above-mentioned problems occurring in the prior art, and an aspect of the present invention is to provide a device and method for sending a reply or forward message with a prefix to identify the message as a reply or forward in a mobile communication terminal even with a limited storage capacity and a limited number of characters. The device and method enable a recipient of the reply or forward message to easily perceive whether the received is an original message, a reply message or a forward message.

Another aspect of the present invention is to provide a device and method for indicating the number of replies exchanged between two mobile communication terminals or the number of forwards of a specific received message, in a case where reply messages have been exchanged more than twice between the two mobile communication terminals or where a user forwards the specific received message to multiple recipients.

In order to accomplish the above aspects of the present invention, there is provided a device for sending a reply message in a mobile communication terminal, which includes a memory for storing messages sent or received; a message number checking unit for checking and outputting the number of messages having the same title; and a control unit for detecting when a user selects a function to input a reply message to a specific one of the received messages stored in the memory, extracting title and sender information from the specific message, generating a title header including at least one of the number of replies exchanged and a prefix indicating a reply to the specific message according to the checked number of messages having the same title, and inputting a reply message including text input by the user, the extracted title, the sender information, and the generated title header.

In accordance with another aspect of the present invention, there is provided a device for sending a forward message in a mobile communication terminal, which includes a memory for storing messages sent or received; a message number checking unit for checking and outputting the number of messages having the same title; and a control unit for detecting when a user selects a function to forward a specific message previously stored in the memory, extracting a title from the specific message, generating a title header including at least one of the number of forwards of the specific message and a prefix indicating a forward of the specific message according to the checked number of messages having the same title, and inputting a forward message including text and recipient information input by the user, the extracted title, and the generated title header.

In accordance with still another aspect of the present invention, there is provided a method for sending a reply message in a mobile communication terminal, which includes detecting whether a user selects a function to input a reply message to a specific received message; extracting title and sender information from the specific message; searching sent or received messages previously stored in a memory to check the number of messages having the same title as the specific message; generating a title header including at least one of the number of replies exchanged and a prefix indicating a reply to the specific message according to the checked number of messages having the same title; and sending a reply message including text input by the user, the extracted title, the sender information, and the generated title header when the user inputs a key to send the reply message.

In accordance with still another aspect of the present invention, there is provided a method for sending a forward message in a mobile communication terminal, which includes detecting when a user selects a function to forward a specific message previously stored in a memory; extracting a title from the specific message; searching sent or received messages previously stored in the memory to check the number of messages having the same title; generating a title header including at least one of the number of forwards of the specific message and a prefix indicating a forward of the specific message according to the checked number of messages having the same title; and sending a forward message including text and recipient information input by the user, the extracted title, and the generated title header.

### BRIEF DESCRIPTION OF THE DRAWINGS

The above and other objects, features and advantages of the present invention will be more apparent from the following detailed description taken in conjunction with the accompanying drawings, in which:

FIGS. 1A to 1D illustrate exemplary displays of messages exchanged between conventional mobile communication terminals;

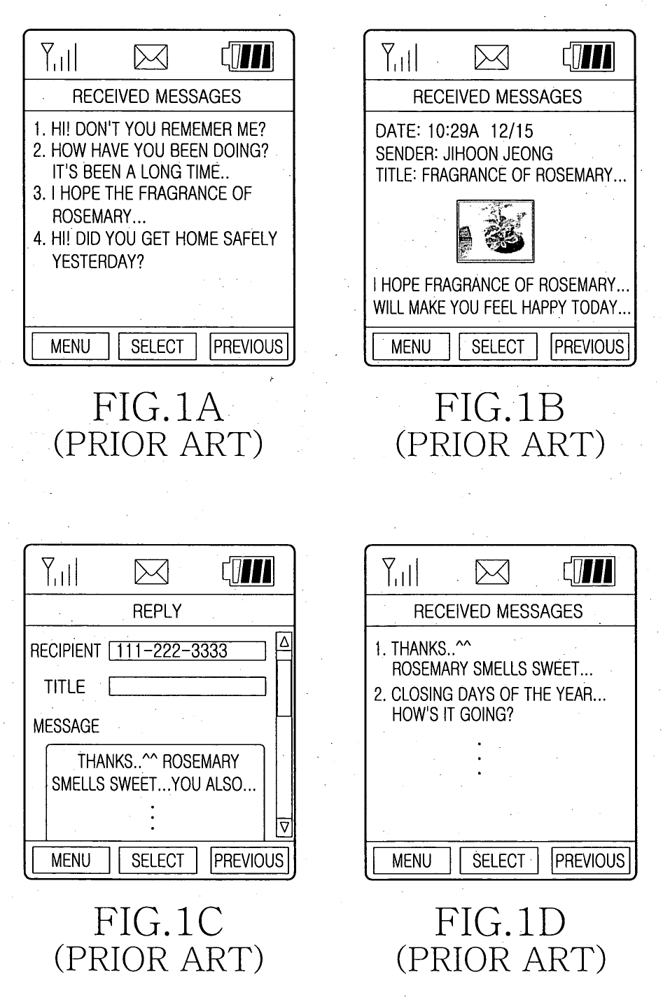

FIG. 2 is a block diagram of a mobile communication terminal according to the present invention;

FIG. 3 is a flowchart showing a process of inputting a reply message according to the present invention;

FIGS. 4A and 4B illustrate a reply message input in a mobile communication terminal and a list of received messages displayed on a counterpart mobile communication terminal according to the present invention;

FIG. 5 is a flowchart showing a process of inputting a forward message according to the present invention;

FIGS. 6A and 6B illustrate a forward message inputted in a mobile communication terminal and a list of received messages displayed on a counterpart mobile communication terminal according to the present invention;

FIG. 7 is a flowchart showing a process of changing a title and a title header of a message according to the present invention; and

FIGS. 8A to 8C illustrate exemplary displays of a message input window during the change of a title and a title header according to the present invention.

### DETAILED DESCRIPTION OF THE PREFERRED EMBODIMENT

Hereinafter, preferred embodiments of the present invention will be described with reference to the accompanying drawings. In the following description of the present invention, a detailed description of known functions and configurations incorporated herein will be omitted when it may make the subject matter of the present invention unclear.

To assist in understanding the present invention, basic principles and functions for carrying out the invention will be briefly explained. When a user selects a function to send a reply or forward message with respect to a specific received message in a mobile communication terminal, the title of the specific message is extracted and set to be the title of the reply or forward message. The mobile communication terminal searches stored sent or received messages to check the number of messages having the same title as the specific message, and then generates an indication of the number of replies or forwards according to the checked number of messages having the same title. Also, the mobile communication terminal generates a title header including an indication of the number of replies or forwards and a prefix indicating a reply or a forward depending on whether the user selected a reply message function or a forward message function. The generated title header is inserted into the subject (title) line. As a result, a reply or forward message including the extracted title and the generated title header can be sent. The recipient who receives the reply or forward message can easily perceive whether the received message is a reply or a forward. At the same time, the recipient can perceive the number of replies exchanged or the number of times the message has been forwarded.

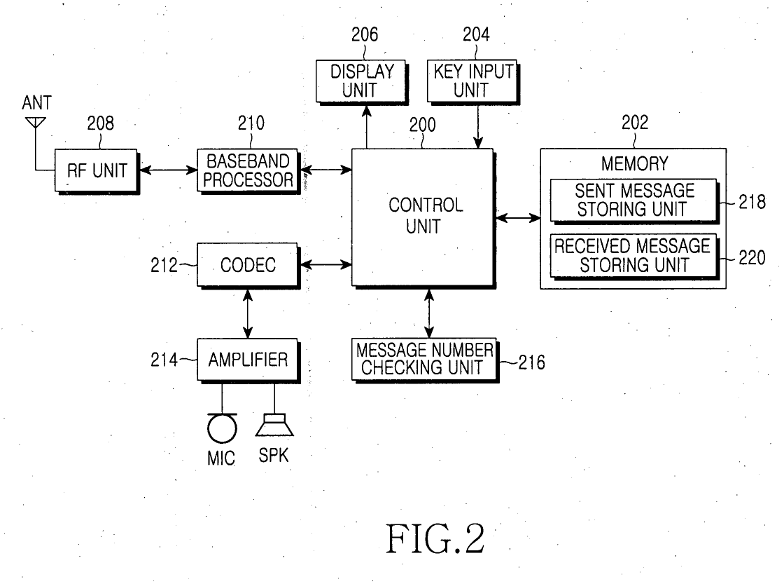

FIG. 2 is a block diagram of a mobile communication terminal according to the present invention.

Referring to FIG. 2, the mobile communication terminal includes a control unit 200, a memory 202, a key input unit 204, a display unit 206, an RF unit 208, a baseband processor 210, a codec (coder-decoder) 212 and a message number checking unit 216. The control unit 200 processes audio signals and data according to the protocols for telephone calls, data communication and wireless Internet access, and controls each part of the mobile communication terminal. When a user presses a key on the key input unit 204, the control unit 200 controls the display unit 206 to generate and output corresponding data.

In addition, when the user selects a reply or forward message menu in relation to a specific message, the control unit 200 extracts the title of the specific message and sets the extracted title as the title of a reply or forward message. The control unit 200 controls the message number checking unit 216 to search messages stored in the memory 202 and to check the number of messages having the same title as the specific message. If only one message has a matching title, the control unit 200 will generate a title header including a prefix indicating a reply or a forward. If two or more messages have the same title, the control unit 200 will generate a title header including the checked number of messages (i.e. the number of replies exchanged under the same title or the number of forwards of the specific message) and a prefix indicating a reply or a forward. Then the control unit 200 sends a reply or forward message including the generated title header and the extracted title according to the user's selection.

The memory 202 connected to the control unit 200 has storage spaces for storing messages sent or received. In the following description, a storage space for storing the sent messages will be referred to as a sent message storing unit 218, and a storage space for storing the received messages as a received message storing unit 220.

The memory 202 comprises a ROM (Read Only Memory), a flash memory and a RAM (Random Access Memory). The ROM stores programs necessary for the processing and controlling of operations of the control unit 200 and various reference data. The RAM provides a working memory of the control unit 200. The flash memory stores various updatable data.

The key input unit 204 with alphanumeric keys and a plurality of function keys transfers data corresponding to the user's key input to the control unit 200. The RF unit 208 sends and receives RF signals to and from a base station. The RF unit 208 converts a received RF signal into an IF (intermediate frequency) signal and outputs the IF signal to the baseband processor 210. Also, the RF unit 208 converts an IF signal input from the baseband processor 210 into an RF signal and sends the RF signal. As a BAA (Baseband Analog ASIC) that provides an interface between the control unit 200 and the RF unit 208, the baseband processor 210 converts a baseband digital signal applied from the control unit 200 into an analog IF signal and applies the analog IF signal to the RF unit 208. The baseband processor 210 converts an analog IF signal applied from the RF unit 208 into a baseband digital signal and applies the digital signal to the control unit 200.

The codec 212 connected to the control unit 200 is also connected to a microphone (MIC) and a speaker (SPK) through an amplifier 214. The codec 212 encodes an audio signal input from the microphone through PCM (Pulse Code Modulation) and outputs the audio data to the control unit 200. Also, the codec 212 decodes audio data received from the control unit 200 through PCM and outputs the decoded data to the speaker through the amplifier 214. The amplifier 214 that amplifies audio signals input from the microphone or output through the speaker adjusts the speaker volume and the microphone gain under the control of the control unit 200.

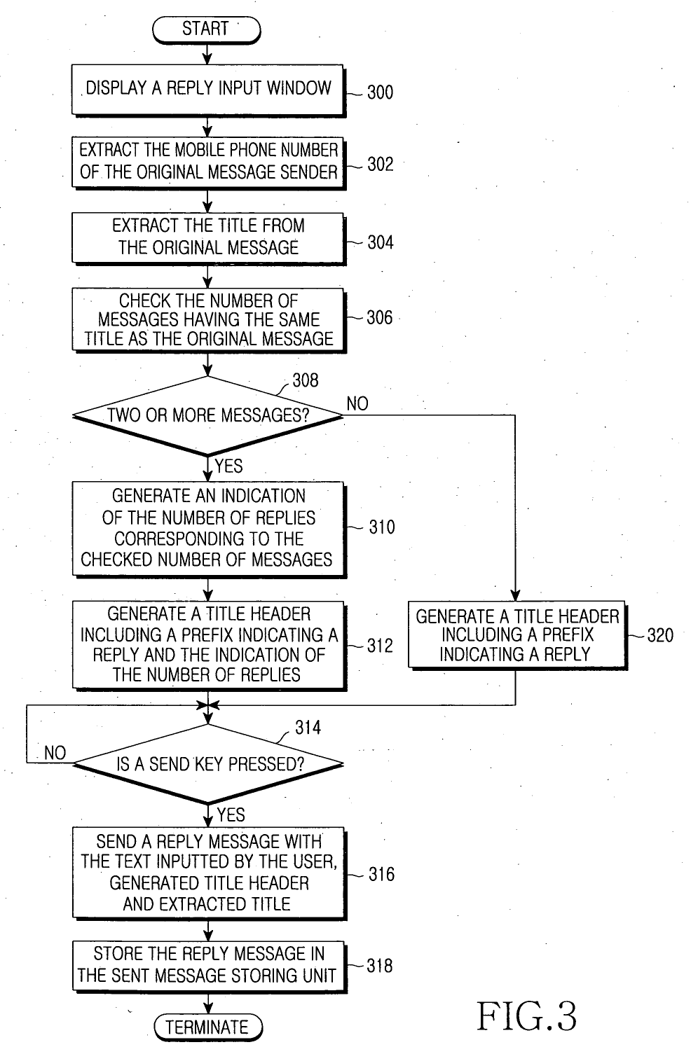

FIG. 3 is a flowchart showing a process of inputting a reply message according to the present invention.

Referring to FIG. 3, when a user selects a specific received message and then a reply message menu, the control unit 200 of the mobile communication terminal proceeds to step 300 in order to display a reply message input window. In step 302, the control unit 200 extracts a mobile phone number from sender information of the selected original message and inserts the extracted telephone number into the reply message input window. In step 304, the control unit 200 extracts the title from the original message and sets the extracted title as the title of a current reply message.

In step 306, the control unit 200 searches the sent message storing unit 218 and the received message storing unit 220 to check or determine the number of messages having the same title as the selected original message. In step 308, the control unit 200 determines whether two or more messages stored in the sent message storing unit 218 and the received message storing unit 220 have the same title as the original message.

If only one message has the title, the control unit 200 will proceed to step 320 in order to generate a title header including a prefix indicating a reply. The prefix indicating a reply can be “RE:” which is commonly used in e-mail messages sent or received on a PC. In step 314, the control unit 200 checks whether the user selects a key to send the current reply message.

If two or more messages having the same title are detected in the sent message storing unit 218 and the received message storing unit 220 in step 308, the control unit 200 will proceed to step 310 in order to generate an indication of the number of messages having the same title (i.e. the number of replies exchanged under the same title). In step 312, the control unit 200 generates a title header which includes the number of replies exchanged and the prefix indicating a reply.

In step 314, the control unit 200 checks whether the user selects a key to send the currently input reply message. If the send key is pressed, the control unit 200 will proceed to step 316 in order to send the reply message, including the text input by the user, the title extracted from the original message and the generated title header, to the original message sender. In step 318, the control unit 200 stores the reply message currently sent to the original message sender in the sent message storing unit 218.

If a user A sends a message with a specific title to a user B, the message will be stored in both the sent message storing unit of user A's mobile communication terminal and the received message storing unit of user B's mobile communication terminal. At this time, both user A's mobile communication terminal and user B's mobile communication terminal have one message stored under that specific title. If the user B selects the reply menu to send a reply message to the user A, user B's mobile communication terminal will check the number of messages stored under the same title as the original message in step 308. Upon detecting that only one message has the specific title, user B's mobile communication terminal will proceed to step 320 in order to generate a title header including only a prefix indicating a reply, i.e. “RE” and send a reply message including the generated title header to user A.

When the reply message is received from user B's mobile communication terminal, user A's mobile communication terminal stores the reply message in the received message storing unit. In other words, user A's mobile communication terminal stores both the original message (in the sent message storing unit) and the reply message (in the received message storing unit) which have the same title. Also, user B's mobile communication terminal stores both the original message (in the received message storing unit) and the reply message (in the sent message storing unit). If user A selects the reply menu in order to reply again to the received reply message, the control unit of user A's mobile communication terminal will check the number of messages stored under the same title as the received reply message (“first reply message”) in step 308. Upon detecting two messages having the same title, user A's mobile communication terminal will proceed to step 310 in order to generate a title header “RE2” and send a reply message (“second reply message”) including the generated title header to the user B.

If the user B replies again to the second reply message, user B's mobile communication terminal will check the number of messages stored under the same title as the second reply message in step 308. Upon detecting that three messages, i.e., the original message, the first reply message having the title header “RE” and the second reply message having the title header “RE2” are stored in the memory, user B's mobile communication terminal will proceed to step 310 in order to generate a title header “RE3” indicating a third reply. Then user B's mobile communication terminal will send a third reply message including the title header “RE3” to user A's mobile communication terminal. Accordingly, a message recipient can easily perceive the number of replies exchanged between the two mobile communication terminals from the title header of the received reply message.

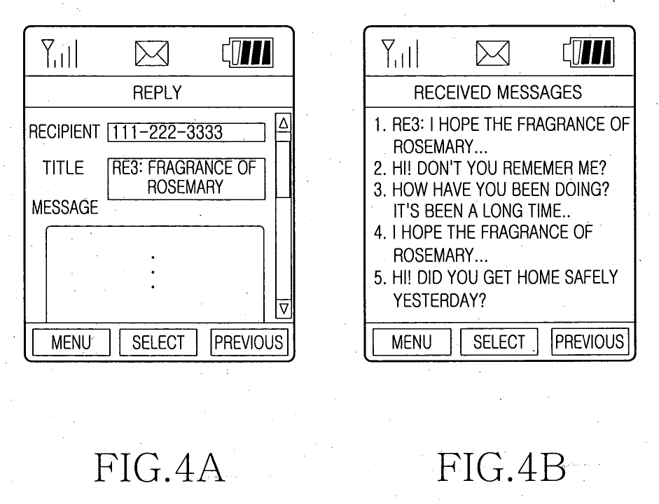

FIGS. 4A and 4B illustrate a reply message input in a mobile communication terminal and a list of received messages displayed on a counterpart mobile communication terminal according to the present invention. FIG. 4A illustrates a reply message which is being input by the user B in the explanation of FIG. 3. The reply message includes a title header indicating that the current reply message is a third reply.

As explained above, the user B's mobile communication terminal stores three messages having the same title, i.e. the original message received from the user A, the first reply message sent to the user A and the second reply message received from the user A. When the user B selects the reply menu in order to reply to the second reply message from the user A, user B's mobile communication terminal generates a title header including a digit “3” indicating the number of messages stored under the same title in step 310. The generated title header is inserted before the title extracted from the previous message as shown in FIG. 4A.

When the third reply message is received from the user B, user A's mobile communication terminal displays a list of received messages including the third reply message having the title header “RE3” as illustrated in FIG. 4B. Accordingly, the user A can perceive that the currently received message is a reply to his or her previous reply message (RE2) which was sent in reply to the user B's first reply message (RE), even without opening the received message.

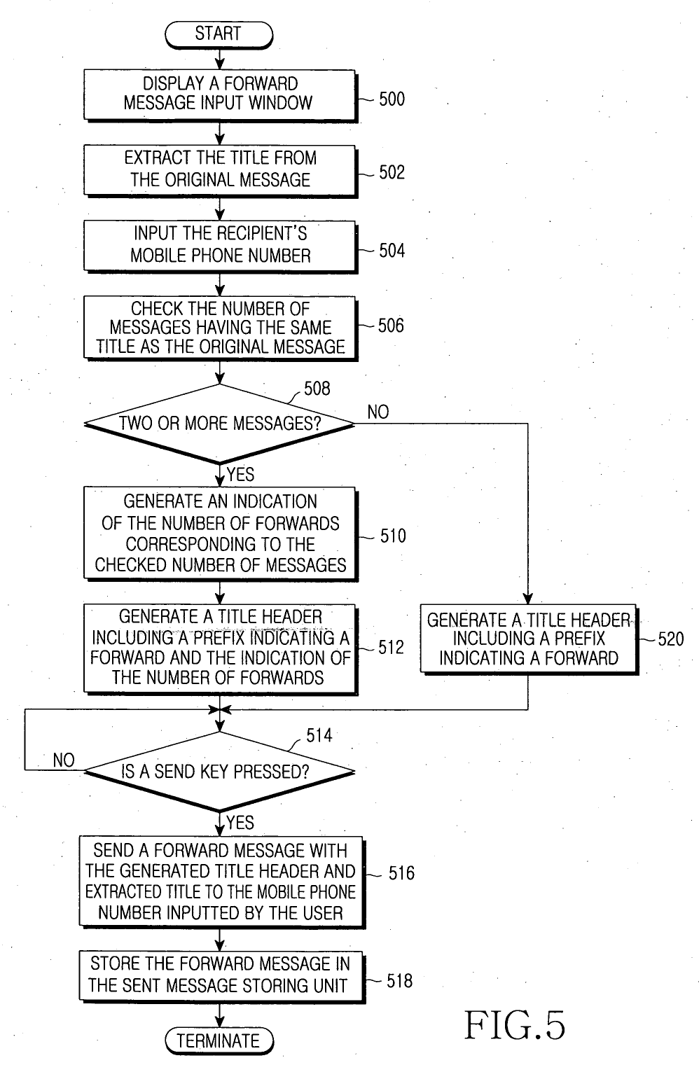

FIG. 5 is a flowchart showing a process of inputting a forward message according to the present invention.

Referring to FIG. 5, if a user selects a forward menu while opening a specific received message, the control unit 200 of the mobile communication terminal proceeds to step 500 in order to display a forward message input window. In step 502, the control unit 200 extracts a title from the selected original message and sets the extracted title as the title of a current forward message.

In step 504, the control unit 200 inserts a recipient's mobile phone number as input by the user into the forward message input window. In step 506, the control unit 200 checks the number of messages having the same title as the original message. In step 508, the control unit 200 determines whether two or more messages stored in the sent message storing unit 218 and the received message storing unit 220 have the same title as the original message.

If only one (original) message has the title, the control unit 200 will proceed to step 520 in order to generate a title header including a prefix indicating a forward. The prefix indicating a forward can be “FW:” which is commonly used in e-mail messages sent or received on a PC. In step 514, the control unit 200 checks whether the user selects a key to send the current forward message.

If two or more messages having the same title are detected in the sent message storing unit 218 and the received message storing unit 220 in step 508, the control unit 200 will proceed to step 510 in order to generate an indication of the number of messages having the same title (i.e. the number of forwards of the original message). In step 512, the control unit 200 generates a title header which includes the number of forwards of the original messages and the prefix indicating a forward.

In step 514, the control unit 200 checks whether the user selects a key to send the currently input forward message. If the send key is pressed, the control unit 200 will proceed to step 516 in order to send the forward message, including the text input by the user, a title extracted from the original message and a generated title header, to the mobile phone number input by the user. In step 518, the control unit 200 stores the forward message currently sent in the sent message storing unit 218.

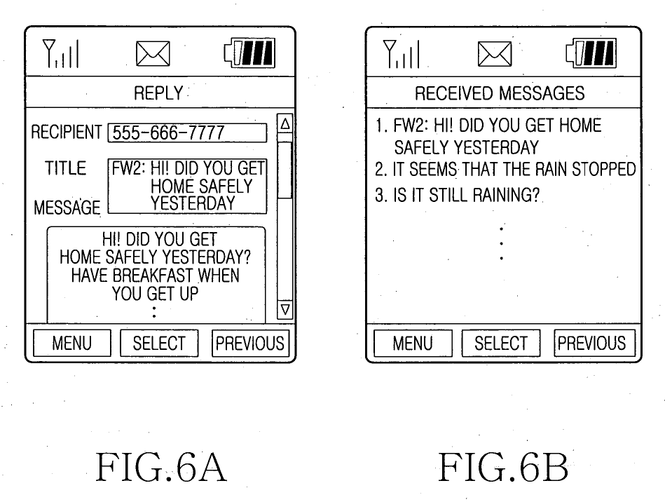

FIGS. 6A and 6B illustrates a forward message input in a mobile communication terminal and a list of received messages displayed on a counterpart mobile communication terminal according to the present invention. FIG. 6A illustrates a forward message input window with a title header including the automatically counted number of forwards of the original message. FIG. 6B illustrates a list of received messages displayed on a counterpart mobile communication terminal that receives the forward message of FIG. 6A.

Referring back to FIG. 5, if the user B selects the forward menu to forward an original message received from the user A to another user (user C), user B's mobile communication terminal will check the number of messages having the same title as the original message. Upon determining that only one (original) message has the title in step 506, the mobile communication terminal proceeds to step 520 in order to generate a title header including only a prefix indicating a forward. If the send key is pressed, user B's mobile communication terminal will proceed to step 516 in order to send the current forward message, including the text inputted by user B, the title extracted from the original message and the generated title header, to user C. The forwarded message will then be stored in the sent message storing unit 218 of the user B's mobile communication terminal.

If user B selects the forward menu again to secondarily forward the original message to another user (user D), user B's mobile communication terminal will check the number of messages having the same title as the original message in step 506. In step 508, user B's mobile communication terminal will determine that there are two messages having the same title, i.e. the original message received from user A and stored in the received message storing unit 220 and the first forward message sent to user C and stored in the sent message storing unit 218. Accordingly, the control unit 200 of user B's mobile communication terminal proceeds to step 510 in order to generate a digit “2” indicating the number of forwards of the original message. FIG. 6A illustrates an example of a forward message input window displayed on the user B's mobile communication terminal.

When the second forward message is received from user B, user D's mobile communication terminal displays a list of received messages including the second forward message having the title header “FW2” as illustrated in FIG. 6B. Accordingly, user D can perceive that the currently received message is the second forward of the original message, even without opening the received message.

Of course, the title headers and titles as exemplified in FIGS. 3 and 5 can be changed by the user. If the user changes the title in a reply or forward message, the reply or forward message recipient's mobile communication terminal will recognize the received reply or forward message as a new message.

In other words, a mobile communication terminal according to the present invention searches messages stored in the sent message storing unit 218 and the received message storing unit 220 to check the number of messages having the same title as the original message and thereby to generate a title header including the number of replies or forwards. If the user changes the title extracted from the original message to a new one in a reply or forward message input window, the mobile communication terminal will not check the number of messages having the same title as the original message in step 306 or 506. It is also possible to change only the title in a reply or forward message, without changing the generated title header.

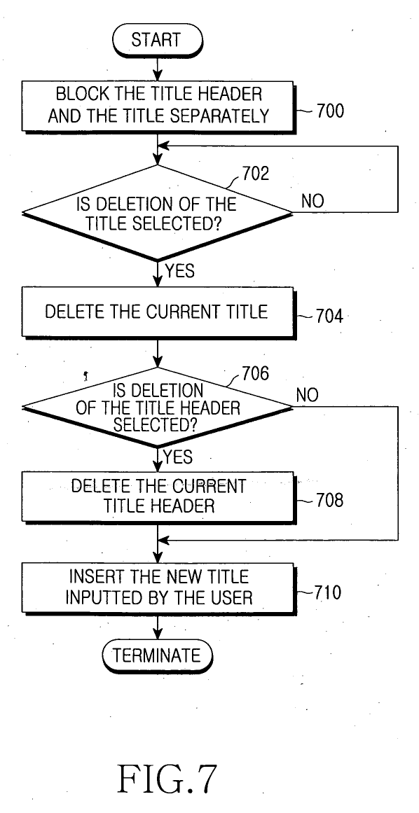

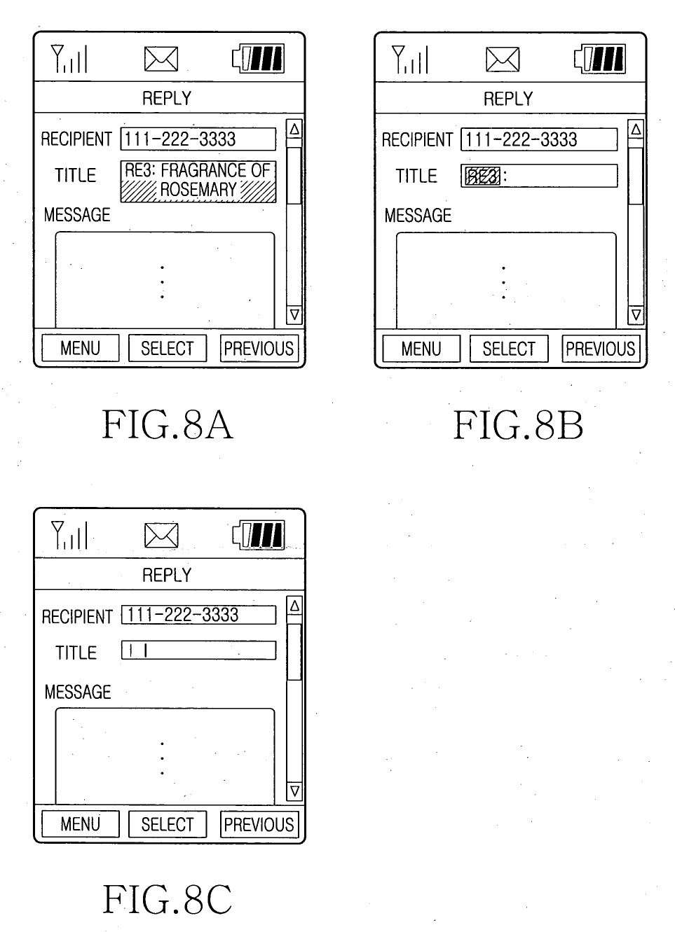

FIG. 7 is a flowchart showing a process of changing a title and a title header of a message according to the present invention. FIGS. 8A to 8C illustrate exemplary displays of a message input window during the change of a title and a title header according to the present invention.

Referring to FIG. 7, the user may select a change of the title before sending a currently input reply or forward message. In such a case, the mobile communication terminal proceeds to step 700 in order to block the title header and the title separately. FIG. 8A illustrates a message input window with a title header and a title separately blocked when the user selects a change of the title.

In step 702, the control unit 200 of the mobile communication terminal checks whether the user selects deletion of the title. The deletion can be selected by directly pressing a delete key or an alphanumeric key for inputting a new title while the previous title is blocked. When the deletion of the title is selected, the control unit 200 proceeds to step 704 in order to delete the title excluding the title header. FIG. 8B illustrates a message input window with the title deleted. Accordingly, the user can change the title only, maintaining the title header before sending a reply or forward message. The recipient of the reply or forward message can perceive that the received message is a reply or a forward from the title header included in the message even if the title is new.

In step 706, the control unit 200 of the mobile communication terminal checks whether the user selects deletion of the title header. The deletion can be selected by pressing the delete key on the blocked title header after deleting the title.

If the user does not select the deletion of the title header in step 706, the control unit 200 will proceed to step 710 in order to allow the user to input a new title, maintaining the current title header. Accordingly, the user can send a reply or forward message under the new title, without changing the title header.

If the user selects the deletion of the title header in step 706, the control unit 200 will proceed to step 708 in order to delete the current title header. FIG. 8C illustrates a message input window with both the title header and the title deleted. In step 710, the control unit 200 inserts the new title input by the user into the message input window. Due to the deletion of the title header and the change of the title, the reply or forward message is sent in form of a new message, rather than of a reply or a forward.

According to the present invention, a reply or forward message can be sent with a prefix indicating the reply or forward even in a mobile communication terminal having a limited storage capacity and a limited number of characters capable of being input in a message so that a recipient of the reply or forward message can easily perceive that the received message is a reply or a forward.

Also, in case where reply messages have been exchanged two or more times between the two mobile communication terminals or where a user forwards the specific received message to multiple recipients, the number of replies exchanged between two mobile communication terminals or the number of forwards of a specific received message can be included in a reply or forward message so that a recipient of the reply or forward message can easily perceive the number of replies or forwards.

Although preferred embodiments of the present invention have been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A device for sending a reply message in a mobile communication terminal, comprising:
a memory for storing messages sent or received by a user;
a message number checking unit for determining and outputting the number of messages having a same title; and
a control unit for detecting when a user selects a function to input a reply message to a specific one of the received messages stored in the memory, extracting title and sender information from the specific message, generating a title header including at least one of an indication of the number of replies exchanged and a prefix indicating a reply to the specific message according to the determined number of messages having the same title, and inputting a reply message including text input by the user, the extracted title, the sender information, and the generated title header.

2. The device according to claim 1, wherein said indication of the number of replies is a digit indicating the number of messages having the same title.

3. The device according to claim 1, wherein said control unit generates a title header including a prefix indicating a reply when only one message having the same title is detected.

4. The device according to claim 1, wherein said prefix indicating a reply is RE.

5. A device for sending a forward message in a mobile communication terminal, comprising:
a memory for storing messages sent or received;
a message number checking unit for determining and outputting the number of messages having the same title; and
a control unit for detecting when a user selects a function to forward a specific message previously stored in the memory, extracting a title from the specific message, generating a title header including at least one of an indication of the number of forwards of the specific message and a prefix indicating a forward of the specific message according to the determined number of messages having the same title, and inputting a forward message including text and recipient information input by the user, the extracted title, and the generated title header.

6. The device according to claim 5, wherein said indication of the number of forwards is a digit indicating the number of messages having the same title.

7. The device according to claim 6, wherein said control unit generates a title header including a prefix indicating a forward when only one message having the same title is detected.

8. The device according to claim 5, wherein said prefix indicating a forward is FW.

9. A method for sending a reply message in a mobile communication terminal, comprising the steps of:
detecting whether a user selects a function to input a reply message to a specific received message;
extracting title and sender information from the specific message;
searching sent or received messages previously stored in a memory to determined the number of messages having the same title as the specific message;
generating a title header including at least one of an indication of the number of replies exchanged and a prefix indicating a reply to the specific message according to the determined number of messages having the same title; and
sending a reply message including text input by the user, the extracted title, the sender information, and the generated title header when the user inputs a key to send the reply message.

10. The method according to claim 9, wherein said step of generating a title header further comprises:
determining if the determined number of messages is greater than or equal to two;
generating an indication of the number of replies which corresponds to the determined number of messages if the number of messages are greater than or equal to two; and
generating a title header including a prefix indicating a reply to the specific message and the generated indication of the number of replies.

11. The method according to claim 9, wherein said step of generating a title header further comprises:
determining if the determined number of messages is greater than or equal to two; and
generating a title header including a prefix indicating a reply to the specific message if the determined number of messages is less than two.

12. The method according to claim 9, wherein said prefix indicating a reply is RE.

13. A method for sending a forward message in a mobile communication terminal, comprising the steps of:
detecting when a user selects a function to forward a specific message previously stored in a memory;
extracting a title from the specific message;
searching sent or received messages previously stored in the memory to determine the number of messages having the same title;
generating a title header including at least one of the number of forwards of the specific message and a prefix indicating a forward of the specific message according to the determined number of messages having the same title; and
sending a forward message including text and recipient information input by the user, the extracted title, and the generated title header.

14. The method according to claim 13, wherein said step of generating a title header further comprises:
determining if the determined number of messages is greater than or equal to two;
generating an indication of the number of forwards which corresponds to the determined number of messages if the messages are greater than or equal to more; and
generating a title header including a prefix indicating a forward of the specific message and the generated indication of the number of forwards.

15. The method according to claim 13, wherein said step of generating a title header further comprises:
determining if the determined number of messages is greater than or equal to two; and
generating a title header including a prefix indicating a forward of the specific message if the determined number of messages is less than two.

16. The method according to claim 13, wherein said prefix indicating a forward is FW.
